(19) United States
(12) Patent Application Publication
(10) Pub. No.: US 2005/0082849 A1
(43) Pub. Date: Apr. 21, 2005

(54) Door lever construction with fragile handle

(76) Inventor: David A. Ebert, Schwenksville, PA (US)

Correspondence Address: CARLSON, GASKEY & OLDS, P.C., 400 WEST MAPLE ROAD, SUITE 350, BIRMINGHAM, MI, 48009, US

(21) Appl. No.: 10/689,230

(22) Filed: Oct. 20, 2003

(51) Int. Cl. E05B 1/00

(52) U.S. Cl. 292/347

(57) ABSTRACT

A unique lever for being turned to actuate a door latch includes a shank mounted to the door. A handle, which is preferably crystal, is attached to an opposed end of the shank. A bolt extends through a bore in the handle and is secured to the shank, and at a remote end, to an end cap. The handle has a portion extending into a shallow pocket in both the shank and the end cap. The overall arrangement provides adequate support and a good force transmission surface from the handle to the shank such that the handle is unlikely to shatter.

### BACKGROUND OF THE INVENTION

This invention relates to a door lever, having a lever handle made of a fragile material, such as crystal, with a unique mounting to minimize the likelihood of the handle fracturing.

Door levers are known that have a pivoting handle essentially cantilevered-mounted from a shank. The handle is turned to turn the shank, and control a latch within a door. Historically, these handles have been made of metal, wood, or some material that is relatively resistant to fracture.

While crystal or glass door handles are known, the same fragile materials have typically not been utilized for the above-described cantilever-mounted door lever handles.

### SUMMARY OF THE INVENTION

In a disclosed embodiment of this invention, a relatively fragile material is utilized to form a handle that is attached to a mount shank in the type of door lever wherein the handle is turned to actuate a door latch. In a preferred embodiment, a shank portion is mount on a door. The shank includes a mount face that includes an inwardly extending shallow pocket. A handle formed of a fragile material has a mating surface that extends into the pocket, abutting an end face of the shank. A bolt extends through a bore in the handle, and a cap member is secured on an outer end of the bolt. Thus, the handle is in compression between the cap and the shank. Preferably, the cap also includes the shallow pocket, with the handle also extending into the cap shallow pocket. In a preferred embodiment, the shallow pockets have a frustro-conical side wall, and the handle has a mating surface extending into and abutting along the frustro-conical side wall. Preferably, the handle is a crystal, and most preferably a leaded glass crystal.

Further, the end face of the handle that abuts the shank and the cap extends for more than 50% of the projected cross-sectional area. That is, the bore through the handle takes up less than 50% of the cross-sectional area, and in a preferred embodiment, less than 33% of the cross-sectional area defined at the end of the handle.

These and other features of the present invention can be best understood from the following specification and drawings, the following of which is a brief description.

### BRIEF DESCRIPTION OF THE DRAWINGS

FIG. 1 is a perspective view of a door lever incorporating the present invention.

FIG. 2 is a cross-sectional view along through the inventive lever.

FIG. 3 is an enlarged view of the portion identified by the circle 3 in FIG. 2.

FIG. 4 is an exploded view of the inventive lever.

### DETAILED DESCRIPTION OF THE PREFERRED EMBODIMENT

A door lever 20 is illustrated in FIG. 1. As is known, a shank 22 is mounted to a door. A central portion of the shank is to be turned relative to an outer portion 23 to actuate a lever within the door (shown schematically at 21). A handle 24 is essentially cantilever-mounted from the shank 22, and provides a force application surface for turning the shank 22. In the inventive embodiment, the handle 24 is not actually cantilever-mounted by itself. Rather, a bolt 26 extends through a central bore 25 and receives an outer end cap 28. Preferably, the shank 22, the bolt 26, and the end cap 28 are all formed of a metal, while the handle 24 is formed of a material that is more fragile than the material of the shank 22, bolt 26, or cap 28. In particular, the handle 24 is preferably a crystal.

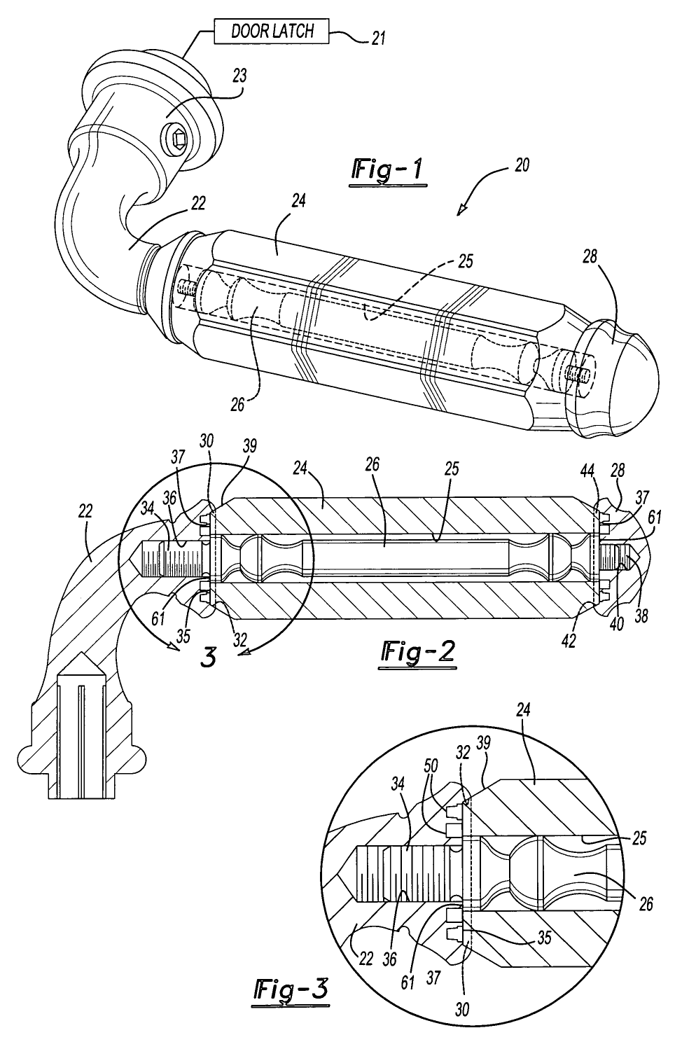

As shown in FIG. 2, the bolt 26 includes threads 34 received in a threaded bore 36 in the shank 22. Similar threads 38 extend into a bore 40 in 28 on an opposed end. When the cap 28 is tightened onto the thread 38, the handle 24 is held in compression between the shank 22 and the cap 28. As can be appreciated, bore 25 in the handle 24 allows passage of the bolt 26. As can also be seen, a shallow pocket 30 is formed in the shank 22, and includes frustro-conical side walls 32, and an end wall 35. The handle 24 has an end face 37 and a frustro-conical end wall 39, that together abut the end wall 35 and frustro-conical inner side wall 32. A similar arrangement is shown at 42 and 44 at the end of the bolt 26 receiving cap 28. The shallow pockets, and closely matched surfaces of the handle 24, provide a solid support surface such that forces are transferred easily from the handle 24 to the shank 22. The frustro-conical shape in particular limits the likelihood of the relatively fragile handle 24 shattering or otherwise fracturing, when a force is applied.

As can also be seen, end faces 61 of the bolt abut a portion of the end faces 35 and 42 of the shank 22 and cap 28, respectively. Further, as can be appreciated from the enlargement of FIG. 3, there are small grooves 50 in the shank 22, and in the cap 28 (see FIG. 2), that receives an adhesive to further secure the cap 28 to the handle 24, and the handle 24 to the shank 22. While many adhesives may be are utilized, in one application, Red Star 509 glue is utilized.

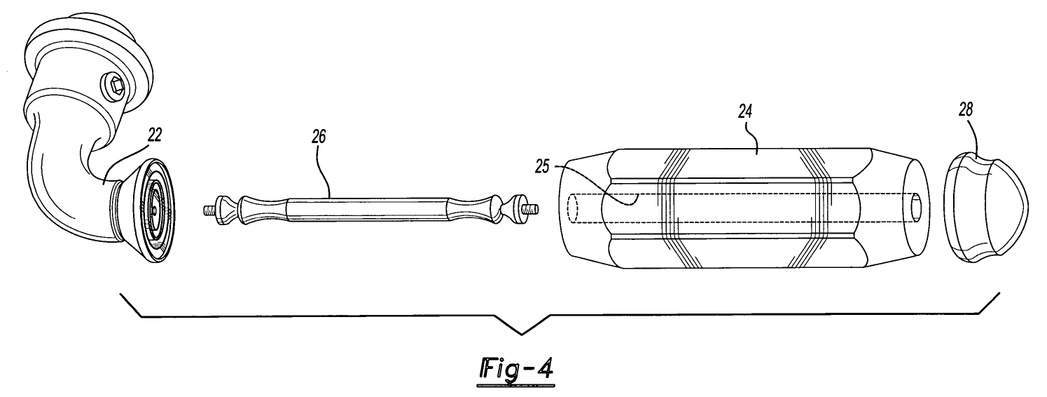

FIG. 4 is an exploded view showing the various components. It should also be understood from the several figures that the size of the end face 37 is relatively large when compared to the overall cross-sectional area of the handle at each end. That is, the area taken by the bore 25 is less than half the actual contact area provided by the surface 32. In preferred embodiments, the bore area 25 is less than one-third the contact area of surface 32. In one embodiment, the bore was nominally 9.3 mm, while the overall edge space was 17.35 mm.

Although preferred embodiments of this invention have been disclosed, a worker of ordinary skill in this art would recognize that certain modifications would come within the scope of this invention. For that reason, the following claims should be studied to determine the true scope and content of this invention.

1. A lever for a door comprising:
a shank to be attached to a door at one end, said shank having an opposed end;
a handle attached to said opposed end of said shank, said handle being formed of a material that is more fragile than a material forming said shank.

2. A lever as set forth in claim 1, wherein said handle is formed of a crystal material.

3. A lever as set forth in claim 1, wherein said handle includes a central bore, and a bolt extends through said central bore, said bolt secured to said shank at one end, and extending through said bore, said bolt receiving a cap at a second opposed end such that said handle is captured between said cap and said shank.

4. A lever as set forth in claim 3, wherein said central bore in said handle has a cross-sectional area that is less than half of the cross-sectional area of a portion of said handle that abuts said end face of said shank.

5. A lever as set forth in claim 1, wherein said shank includes a shallow pocket defined by an end face and an inner side wall, said handle extending into said shallow pocket, and said handle having an end face abutting said end face of said shank pocket, and said handle having an outer side wall in engagement with said inner side wall of said shank.

6. A lover as set forth in claim 5, wherein said inner side wall of said shank and said outer side wall of said handle are both frustro-conical.

7. A lever as set forth in claim 6, wherein a cap is attached to said handle, and has a shallow pocket with an end face and a side wall, and said handle further extending into said shallow recess in said cap.

8. A lever for a door comprising:
a metal shank to be attached to a door at one end, said shank having an opposed end;
a handle attached to said opposed end of said shank, said handle being formed of crystal, said handle including a central bore, and a bolt extending through said central bore, said bolt secured to said shank at one end, and extending through said bore, said bolt receiving a cap at a second opposed end such that said handle is captured between said cap and said shank;
said bore having a cross-sectional area that is less than half of the cross-sectional area of an end portion of said handle that abuts said end face of said shank; and
said shank and said cap each including a shallow pocket defined by an end face and an inner side wall, said handle extending into both said shallow pockets, and said handle having end faces abutting said end face of said shank pockets, and said handle having outer side Walls in engagement with said inner side walls of said shallow pockets, said inner side wall of said shallow pockets and said outer side wall of said handle being frustro-conical.

9. A lever for a door as set forth in claim 8, wherein said bore in said handle has a cross-sectional area that is less than half of the cross-sectional area of a portion of said handle that abuts said end face of said shank.

10. A lever for a door as set forth in claim 8, wherein said cap has threads, and said cap being threaded onto said bolt, such that said handle being held in compression between said shank and said cap by said cap having been tightened on said bolt.

11. A lever as set forth in claim 3, wherein said cap has threads, and said cap being threaded onto said bolt, such that said handle being held in compression between said shank and said cap by said cap having been tightened on said bolt.
